(19) United States
(12) Patent Application Publication
(10) Pub. No.: US 2025/0172285 A1
(43) Pub. Date: May 29, 2025

(54) Umbrella with a Flexible Light Strip

(71) Applicant: Wuxi Huirui Electronics Co., Ltd., Wuxi (CN)

(72) Inventor: Liguo Chen, Wuxi (CN)

(21) Appl. No.: 18/605,931

(22) Filed: Mar. 15, 2024

(30) Foreign Application Priority Data
Nov. 23, 2023 (CN) 202323169905.5

(51) Int. Cl. F21V 33/00; A45B 23/00; F21S 4/24

(52) U.S. Cl. CPC F21V 33/008; A45B 23/00; F21S 4/24; A45B 2023/0012; A45B 2023/0037; A45B 2023/0068; A45B 2200/1018

(57) ABSTRACT

An umbrella with a flexible light strip of the present invention has an umbrella body and a flexible light strip. The flexible light strip comprises a connecting portion, a light tape and a diffused portion; the flexible light strip is connected to the umbrella body via the connecting portion and has a long groove inside the connecting portion; the light tape is disposed in the groove; the diffused portion is connected to the connecting portion and is in a certain shape to diffuse the light of the light tape. The umbrella with a flexible light strip of the present invention realizes atmosphere construction and illumination, the flexible light strip has the long groove inside the connecting portion, and the flexible light tape passes through the groove to realize the lighting of the whole diffused portion, so that the whole flexible light strip emits light in a diffusion manner.

### TECHNICAL FIELD OF THE INVENTION

The present invention relates to a field of umbrellas, and in particular to an umbrella with a flexible light strip.

### BACKGROUND OF THE INVENTION

With the development of tourism, umbrellas have become necessary outdoor leisure items in squares, beaches, parks, gardens or similar places to provide an individual with a comfortable leisure and shading space. In order to satisfy different users' demands, the existing umbrellas have increasing functions. Umbrellas with steering functions can adjust an orientation of umbrellas according to different requirements to achieve the best shading effects of the umbrellas.

In order to achieve the purpose of energy saving and environmental protection, solar umbrellas are designed, such as umbrellas with LED lights, so that it is convenient for individuals to have entertainment activities under umbrellas at night. However, the existing umbrellas with lights basically use light guide strips to diffuse light and are made of hard acrylic. The acrylic is easily broken and limited by shape, and thus cannot be used for illumination. For the acrylic light guide strips, light is generally emitted at two ends of each light strip, and the light emitted at two ends is diffused into the whole light guide strips by reflection or refraction. However, under this design, when the light guide strip is too long, a shadow area is easy to appear in a middle of the light guide strip, and the light at two ends cannot be refracted or diffused to the middle area, resulting in shadow and affecting the use. Moreover, the conventional acrylic light guide strips cannot be used for illumination due to their complicated manufacturing process, low yield, inability to bend and low brightness.

### SUMMARY OF THE INVENTION

It is an object of the present invention to provide an umbrella with a flexible light strip so as to solve the problem of the above-mentioned umbrellas in the prior art.

For achieving the above object, the umbrella with a flexible light strip comprises an umbrella body and a flexible light strip disposed on the umbrella body;
the flexible light strip comprises a connecting portion, a light tape and a diffused portion;
the flexible light strip is connected to the umbrella body via the connecting portion and has a long groove inside the connecting portion extending along the light strip;
the light tape is arranged in the groove extending along the flexible light strip and has a power connector, a battery pack is disposed on a column to supply power to the power connector;
the diffused portion is connected to the connecting portion and is in a certain shape to diffuse the light of the light tape.

Preferably, a solar rechargeable panel can also be arranged on the column, and the battery pack is charged by the solar rechargeable panel so that the battery pack can be charged not only by commercial power but also by solar energy.

An external cable can also be arranged in the column, so that the commercial power is connected through the external cable, and the external cable is connected to the power connector, thereby supplying power to the light tape.

The power connector has a cable with a predetermined length. In order to hide the power connector and the cable, the power connector and the cable can be attached to a long rod or a short rod to enter the column, so as to be connected to the battery pack or the external cable.

It is also possible that each long rod and each short rod has a slot inside, the power connector and the cable are hidden in the slot, the column has a hole on a surface of the column so that the power connector and the cable can be placed in the column and then connect to the battery pack or the external cable through the hole.

When the battery pack is mounted on the column, a connector of the battery pack extends into the column, so that the power connector and the cable can be connected in the column to realize power supply.

The light tape comprises an FPC flexible circuit board and a plurality of lamp beads arranged on the FPC flexible circuit board.

The power connector is arranged on the FPC flexible circuit board.

The umbrella with a flexible light strip of the present invention realizes atmosphere construction and illumination by the flexible light strip on the umbrella body, the flexible light strip has the long groove inside the connecting portion, and the flexible light tape passes through the groove to realize the lighting of the whole diffused portion, so that the whole flexible light strip emits light in a diffusion manner. Compared with the conventional light strip which emits light at two ends of the light strip, the flexible light strip has no shadow and will not affect light emission. Moreover, the brightness can be better improved for illumination.

Preferably, since the conventional light strip has shadow and insufficient brightness, it can only be used as an atmosphere lamp and cannot be used for illumination. However, the umbrella with a flexible light strip of the present invention can be used for atmosphere construction and illumination.

Preferably, the conventional light guide strip is basically made of acrylic board and a reflective paper or light guide paper is arranged in the acrylic board, so that the whole light guide strip cannot be changed in shape according to a service environment, and the light guide strip only has a fixed strip shape and cannot be bent. However, in the umbrella with a flexible light strip of the present invention, the flexible light strip is made of a flexible silicone material, can be arbitrarily bent and can be changed in shape according to users' preferences, so that the umbrella with a flexible light strip of the present invention has a larger range of application.

Compared with a manufacturing cost of the conventional light guide strip made of the acrylic and the reflective paper, the manufacturing cost of the umbrella with a flexible light strip of the present invention is lower since the umbrella of the present invention is made of the silicone material. No matter from the perspective of raw material or technology, both cost reduction and function improvement are realized.

Preferably, the lamp beads at two ends of the conventional light guide strips are fixedly connected to the acrylic boards by screws or twining with a heat shrinkage film. Under such design, it is inconvenient for disassembling. Once a lamp bead is damaged, the whole light guide strip needs to be disassembled. However, in the umbrella with a flexible light strip of the present invention, the flexible light tape directly passes through the groove. Once the light tape is damaged, the light strip can be directly pulled out and replaced separately, without replacing the whole flexible light strip. The flexible light strip can also be pulled of the rod for replacement, without disassembling the main structure of the umbrella.

The conventional acrylic light guide strips cannot be cut off. However, the flexible light strip of the present invention can be cut off. The flexible light strip is cut off at a certain length according to users' needs, and a corresponding light tape is matched.

Compared with the conventional acrylic boards, the umbrella with a flexible light strip of the present invention is more convenient to carry and can realize the effect of neon lights.

By matching the flexible light strip with the rod, the atmosphere effect and the illumination effect can be achieved.

Preferably, the connecting portion and the diffused portion are made of a flexible silicone material.

Preferably, the umbrella body comprises:
a column having a top, an upper nest, a lower nest, and a plurality of short rods and a plurality of long rods each having a first end and a second end;
the upper nest is disposed on the top of the column, the long rods are each hinged on a periphery of the upper nest, an umbrella canopy covers the long rods;
the lower nest is movably sleeved around the column and located below the upper nest, the first end of each short rod is hinged on a periphery of the lower nest, the second end of each short rod is hinged on one corresponding long rod of the plurality of long rods;
each long rod is hinged to the corresponding short rod.

Preferably, the umbrella has a plurality of flexible light strips, and the connecting portion of each light strip is connected to one corresponding long rod of the plurality of long rods; each long rod has a slot for receiving the connecting portion. Or, the umbrella has a plurality of flexible light strips, and the connecting portion of each light strip is connected to one corresponding short rod of the plurality of short rods; each short rod has a slot for receiving the connecting portion. Or the umbrella has a plurality of flexible light strips, and the connecting portion of each light strip is connected to both one corresponding long rod and one corresponding short rod; both long rod and short rod have a slot for receiving the connecting portion.

Preferably, the umbrella has a plurality of flexible light strips, each long rod is connected to a frame, and the frame has a through groove for receiving the connecting portion, the connecting portion of each flexible light strip is located in the through groove of a corresponding frame. Or, the umbrella has a plurality of flexible light strips, each short rod is connected to a frame, and the frame has a through groove for receiving the connecting portion, the connecting portion of each flexible light strip is located in the through groove of a corresponding frame. Or, the umbrella has a plurality of flexible light strips, both the long rod and the short rod are connected to a frame, and the frame has a through groove for receiving the connecting portion, the connecting portion of each flexible light strip is located in the through groove of a corresponding frame.

When the flexible light strip is connected to the long rod and/or short rod, the long rod and/or short rod can be directly slotted to adapt to the connecting portion of the flexible light strip, so that the flexible light strip is clamped into the long rod and/or short rod to complete installation. While under such design, the structural strength of the long rod and/or short rod is easily affected so that it is not recommended to adopt this design when the long rods are relatively heavy.

The frame can also be used in combination with the rods. The frame is connected to the long rod and/or short rod, and the frame has the through groove for receiving the connecting portion, so that the flexible light strip is clamped into the frame to realize the connection to the umbrella body.

Preferably, the shape of the diffused portion is a hollow cylinder.

Preferably, the shape of the diffused portion is a hollow cylinder with an interior recessed concave portion and two interior flat sloped planes, wherein each flat sloped plane is disposed adjacent to the recessed concave portion on opposite sides.

Compared with the prior art, the present invention has the following advantages. The umbrella with a flexible light strip of the present invention realizes atmosphere construction and illumination by the flexible light strip on the umbrella body, the flexible light strip has the long groove inside the connecting portion, and the flexible light tape passes through the groove to realize the lighting of the whole diffused portion, so that the whole flexible light strip emits light in a diffusion manner. Compared with the conventional light strip which emits light at two ends of the light strip, the flexible light strip has no shadow and will not affect light emission.

### BRIEF DESCRIPTION OF THE DRAWINGS

FIG. 1 is a perspective view of an umbrella with a flexible light strip according to Embodiment 1 of the present invention when the umbrella body is a cantilever-type umbrella;

FIG. 2 is a perspective view of an umbrella with a flexible light strip according to Embodiment 1 of the present invention when the umbrella body is a straight-column-type umbrella;

FIG. 3 is a sectional view of a flexible light strip and a frame according to Embodiment 1 of the present invention;

FIG. 4 is a perspective view of the flexible light strip and the frame according to Embodiment 1 of the present invention when they are connected;

FIG. 5 is an exploded view of FIG. 4;

FIG. 6 is a perspective view of the flexible light strip and the frame according to Embodiment 2 of the present invention when they are connected;

FIG. 7 is a sectional view of FIG. 6;

FIG. 8 is an exploded view of FIG. 6.

### DETAILED DESCRIPTION OF THE INVENTION

The present invention will be further described below in detail by embodiments with reference to the accompanying drawings.

### Embodiment 1

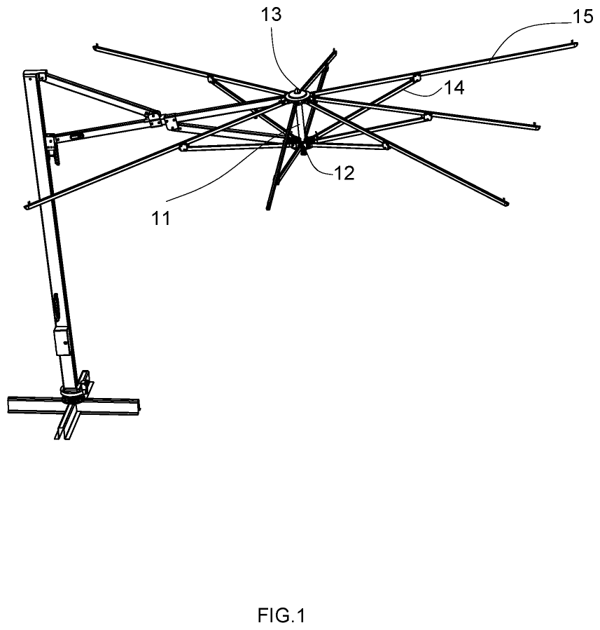

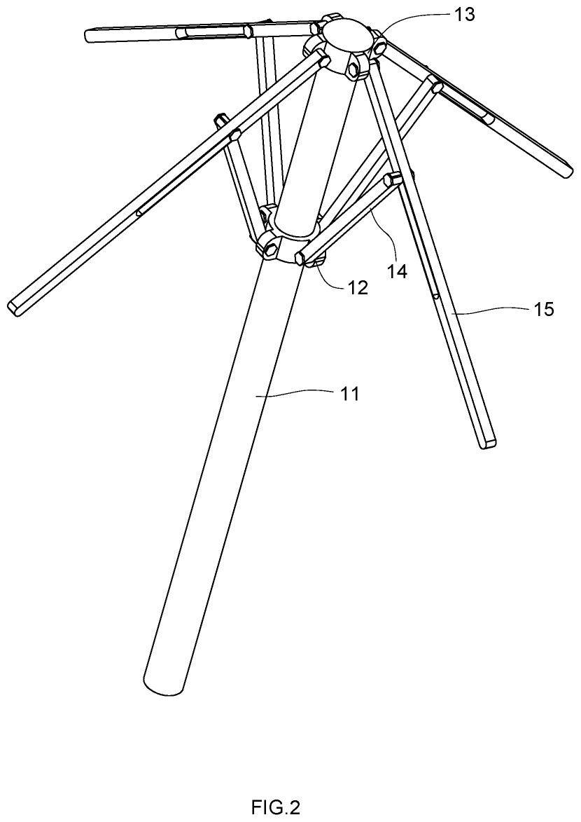

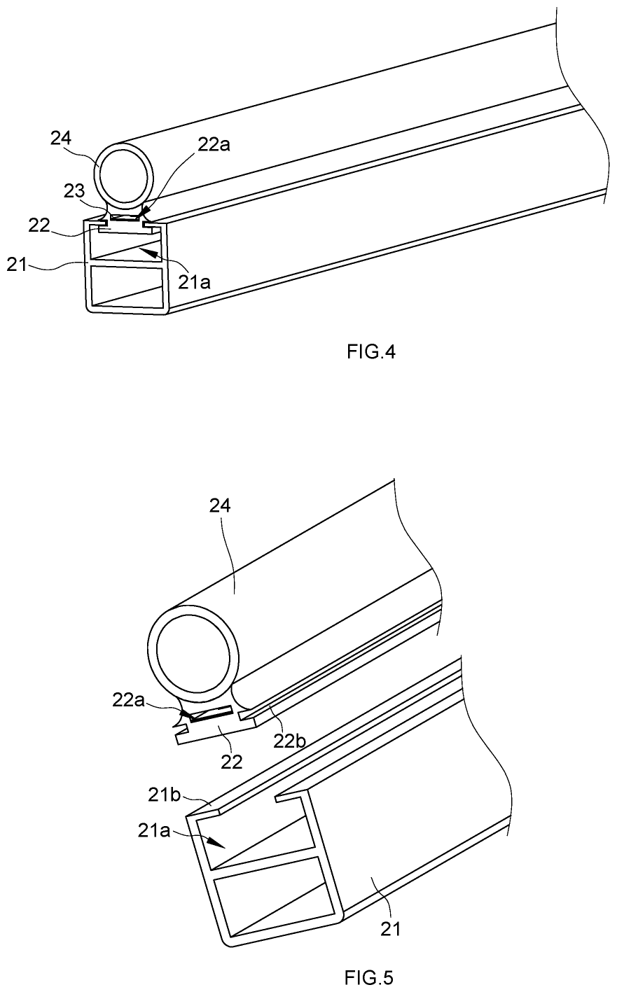

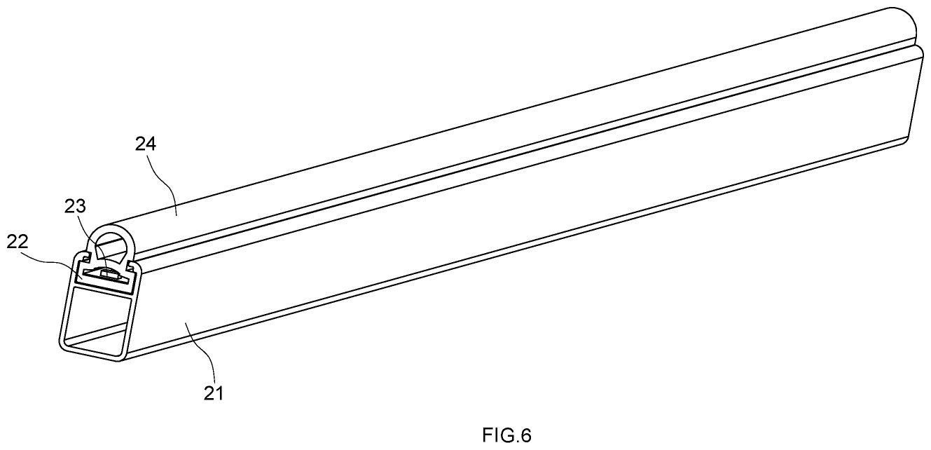

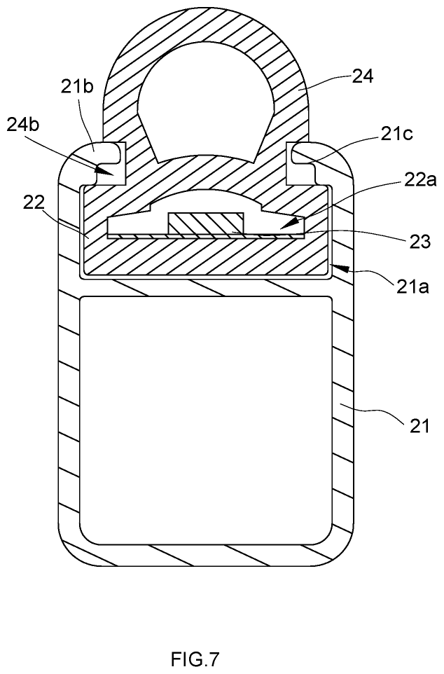

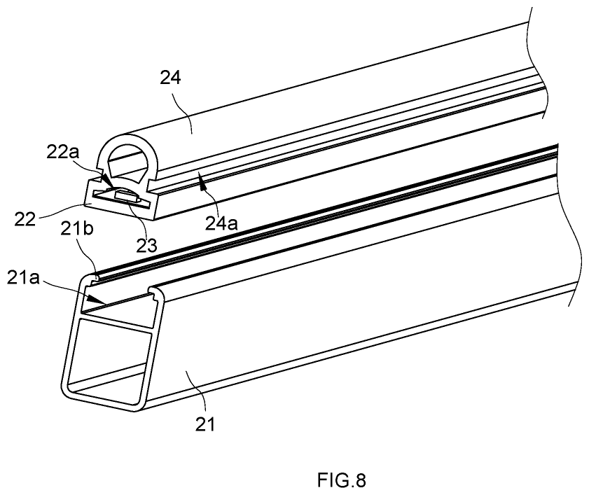

FIGS. 1-5 shows a first preferred embodiment of the umbrella with a flexible light strip of the present invention. The umbrella with a flexible light strip comprises:
an umbrella body and a flexible light strip disposed on the umbrella body;
the flexible light strip comprises a connecting portion 22, a light tape 23 and a diffused portion 24;
the flexible light strip is connected to the umbrella body via the connecting portion 22 and has a long groove 22a inside the connecting portion 22 extending along the light strip;
the light tape 23 is disposed in the groove 22a extending along the flexible light strip;
the diffused portion 24 is connected to the connecting portion 22 and is in a certain shape to diffuse the light of the light tape 23.

The umbrella with a flexible light strip of the present invention realizes atmosphere construction and illumination by the flexible light strip on the umbrella body, the flexible light strip has the long groove 22a inside the connecting portion 22, and the flexible light tape 23 passes through the groove 22a to realize the lighting of the whole diffused portion 24, so that the whole flexible light strip emits light in a diffusion manner. Compared with the conventional light strip which emits light at two ends of the light strip, the flexible light strip has no shadow and will not affect light emission.

Preferably, since the conventional light strip has shadow and insufficient brightness, it can only be used as an atmosphere lamp and cannot be used for illumination. However, the umbrella with a flexible light strip of the present invention can be used for atmosphere construction and illumination.

Preferably, the conventional light guide strip is basically made of acrylic board and a reflective paper or light guide paper is arranged in the acrylic board, so that the whole light guide strip cannot be changed in shape according to a service environment, and the light guide strip only has a fixed strip shape and cannot be bent. However, in the umbrella with a flexible light strip of the present invention, the flexible light strip is made of a flexible silicone material, can be arbitrarily bent and can be changed in shape according to users' preferences, so that the umbrella with a flexible light strip of the present invention has a larger range of application.

Compared with a manufacturing cost of the conventional light guide strip made of the acrylic and the reflective paper, the manufacturing cost of the umbrella with a flexible light strip of the present invention is lower since the umbrella of the present invention is made of the silicone material. No matter from the perspective of raw material or technology, cost reduction is realized.

Preferably, the lamp beads at two ends of each conventional light guide strip are fixedly connected to the acrylic boards by screws or twining with a heat shrinkage film. Under such design, it is inconvenient for disassembling. Once a lamp bead is damaged, the whole light guide strip needs to be disassembled. However, in the umbrella with a flexible light strip of the present invention, the flexible light tape 23 directly passes through the groove 22a. Once the light tape 23 is damaged, the light tape 23 can be directly pulled out and replaced separately, without replacing the flexible light strip and disassembling the main structure of the umbrella.

The conventional acrylic light guide strips cannot be cut off. However, the flexible light strip of the present invention can be cut off. The flexible light strip is cut off at a certain length according to users' needs, and a corresponding light tape 23 is matched.

Compared with the conventional acrylic boards, the umbrella with a flexible light strip of the present invention is more convenient to carry and can realize the effect of neon lights.

The connecting portion 22 and the diffused portion 24 are made of a flexible silicone material.

The umbrella body comprises a column 11 having a top, an upper nest 13, a lower nest 12, and a plurality of short rods 14 and a plurality of long rods 15 each having a first end and a second end;
the upper nest 13 is disposed on the top of the column 11, the long rods 15 are each hinged on a periphery of the upper nest 13;
the lower nest 12 is movably sleeved around the column 11 and located below the upper nest 13, the first end of each short rod 14 is hinged on a periphery of the lower nest 12, the second end of each short rod 14 is hinged on one corresponding long rod 15 of the plurality of long rods 15;
each long rod 15 is hinged to the corresponding short rod 14.

In this embodiment, the umbrella has a plurality of flexible light strips, each long rod 15 and/or each short rod are/is connected to a frame 21, and the frame 21 has a through groove 21a for receiving the connecting portion 22; the connecting portion 22 of each flexible light strip is located in the through groove 21a of a corresponding frame 21 so that the flexible light strip connects to the frame 21.

The flexible light strip can be directly connected to the long rod 15 and/or short rod 14, in detail, the long rod 15 and/or short rod 14 can be directly slotted to adapt to the connecting portion 22 of the flexible light strip, so that the flexible light strip is clamped into the slot of the long rod 15 and/or short rod 14 to complete installation. While under such design, the structural strength of the long rod 15 and/or short rod 14 is easily affected.

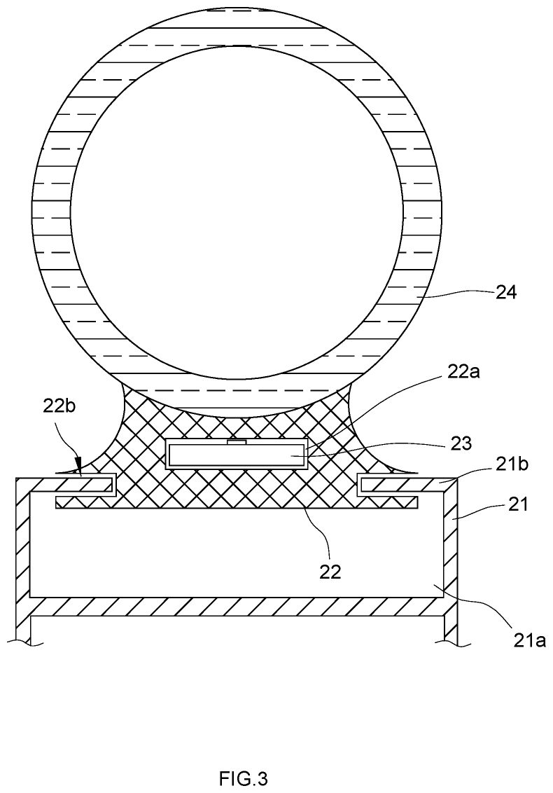

In this embodiment, the frame 21 can also be used in combination with the rods. The frame is connected to the long rod 15 and/or short rod 14, and the frame 21 has the through groove 21a for receiving the connecting portion 22. The frame 21 has two extending edges 21b each extending from the top of the frame 21 to the connection portion 22, correspondingly, the connection portion 22 has two receiving grooves 22b for receiving the extending edges 21b at a right side and left side of the connection portion 22. When the connection portion 22 of the flexible light strip is clamped with the frame 21 and each extending edge 21b is located inside the corresponding receiving groove 22b, the flexible light strip is then mounted on the umbrella body, as shown in FIGS. 3, 4 and 5.

The operation principle is given below: the light tape 23 is electrified, and the light is diffused by the diffusion portion 24, so that the atmosphere construction and illumination with in a predetermined range are realized.

### Embodiment 2

FIGS. 6 and 8 show a second preferred embodiment of the umbrella with a flexible light strip of the present invention. The umbrella in this embodiment differs from that in Embodiment 1 in that: each long rod 15 and/or each short rod 14 is/are connected to the frame 21, and the frame 21 has a through groove 21a for receiving the connecting portion 22. The frame 21 has two extending edges 21b each extending from the top of the frame 21 to the connection portion 22, each extending edge 21b has a step 21c at an end surface of each extending edge 21b;
correspondingly, the diffused portion 24 has two receiving slots 24b for receiving the corresponding extending edge 21b at a right side and left side of the diffused portion 24. When the connection portion 22 of the flexible light strip is located inside the through groove 21a of the frame 21 and each edge 21b is located inside the corresponding receiving slot 24b, the flexible light strip is then mounted on the umbrella body.

In this embodiment, the connecting portion 22 and the diffused portion 24 are in one integral component and both made of a flexible silicon material, so that it is easy to make the connecting portion 22 and the diffused portion 24 be connected to the frame 21.

1. An umbrella with a flexible light strip, comprising:
an umbrella body and a flexible light strip disposed on the umbrella body;
wherein,
the flexible light strip comprises a connecting portion, a light tape and a diffused portion;
the flexible light strip is connected to the umbrella body via the connecting portion and has a long groove inside the connecting portion extending along the light strip;
the light tape is disposed in the groove extending along the flexible light strip;
the diffused portion is connected to the connecting portion and is in a certain shape to diffuse the light of the light tape.

2. The umbrella of claim 1, wherein the connecting portion and the diffused portion are made of a flexible silicone material.

3. The umbrella of claim 1, wherein the umbrella body comprises a column having a top, an upper nest, a lower nest, and a plurality of short rods and a plurality of long rods each having a first end and a second end;
the upper nest is disposed on the top of the column, the long rods are each hinged on a periphery of the upper nest;
the lower nest is movably sleeved around the column and located below the upper nest, the first end of each short rod is hinged on a periphery of the lower nest, the second end of each short rod is hinged on one corresponding long rod of the plurality of long rods.

4. The umbrella of claim 3, wherein the umbrella has a plurality of flexible light strips, and the connecting portion of each light strip is connected to one corresponding long rod of the plurality of long rods;
each long rod has a slot for receiving the connecting portion.

5. The umbrella of claim 3, wherein the umbrella has a plurality of flexible light strips, and the connecting portion of each light strip is connected to one corresponding short rod of the plurality of short rods;
each short rod has a slot for receiving the connecting portion.

6. The umbrella of claim 3, wherein the umbrella has a plurality of flexible light strips;
each long rod is connected to a frame, and the frame has a through groove for receiving the connecting portion;
the connecting portion of each flexible light strip is located in the through groove of a corresponding frame.

7. The umbrella of claim 3, wherein the umbrella has a plurality of flexible light strips;
each short rod is connected to a frame, and the frame has a through groove for receiving the connecting portion;
the connecting portion of each flexible light strip is located in the through groove of a corresponding frame.

8. The umbrella of claim 1, wherein the shape of the diffused portion is a hollow cylinder.

9. The umbrella of claim 1, wherein the shape of the diffused portion is a hollow cylinder with an interior recessed concave portion and two interior flat sloped planes, wherein each flat sloped plane is disposed adjacent to the recessed concave portion on opposite sides thereof.
